(19) United States
(12) Patent Application Publication
(10) Pub. No.: US 2007/0274072 A1
(43) Pub. Date: Nov. 29, 2007

(54) Electric light strings

(76) Inventor: Frank Joseph Prineppi, Freeport (BS)

Correspondence Address: FRANK PRINEPPI, 1323 SE 17th St., PMB 341, FT. Lauderdale, FL, 33316, US

(21) Appl. No.: 11/438,425

(22) Filed: May 23, 2006

(51) Int. Cl. F21V 33/00

(52) U.S. Cl. 362/253

(57) ABSTRACT

An electrically operable ornament display device powered from a pigtail connection to a novelty electric light string includes a housing for an electric motor and one or more electric lamps which extend from the housing and are adapted to illuminate an ornament is supported by the motor, with a control circuit being operable to modulate the supply of electricity to the or each lamp to a selected condition, such as flashing or steady state. In a second embodiment the ornament display device excludes the electric motor and ornaments can be hung directly from underneath the housing via a hook. In both embodiments an adapter may be inserted between the pigtail connection and the light string to control voltage and current, and arrest the flow of current in the event of overheating or voltage overload.

This invention relates to electric light strings of the type used to decorate e.g. Christmas trees or buildings at such festive times.

### BACKGROUND OF THE INVENTION

In my U.S. Pat. No. 5,568,970 I describe a synchronous electric motor which can be plugged into a socket of a conventional light string by means of a “pigtail”, being a short length of wires connected at one end to the motor and at the other end to a plug of size and shape corresponding to the insertion end of a novelty electric light bulb and being inserted in place thereof so that the motor can then provide animation for an ornament, such as a novelty spider which, upon detection of movement within a given range, drops from a reel to which it is attached by a line as if a real spider has dropped from e.g. the ceiling, to thereafter be immediately rewound onto the reel by the synchronous electric motor. Other kinds of animation ornaments are well known in the art, as well as ornaments which can be illuminated and/or provide audio effects, all of which being powered from the light string via a pigtail connection.

Whilst these various electrically operated ornaments provide an interesting and stimulating addition to conventional light strings, in order to comply with Federal, State or customer-enforced regulations they have to be individually tested by e.g. Underwriters Testing Laboratories (UL), which is time consuming for all concerned and therefore increases the cost and complexity of bringing such ornaments to the market, with each such ornament having to undergo rigorous testing to ensure that any risk of electric shock or overheating of the ornament is minimised. In turn, this means that such ornaments are usually powered from electric cables capable of withstanding line voltage, such as 120 volts, of sufficient diameter to exclude the possibility of overheating so that, even though the ornament itself may only require modest power to operate, relatively thick wires etc are used, which can therefore be unsightly. There are also numerous warning labels that are required to be attached to such ornaments and/or wiring, which effectively have to deal with a “worse case” of line voltage being applied to the ornament due to a fault in the light string or just because a relatively large number of light bulbs with oxide shunts which conduct electricity when the bulbs filaments have broken, thereby increasing the applied voltage from the usually series-wired light string.

The present invention is arrived from the realisation that the foregoing disadvantages may be obviated by providing a universal pigtail adapter means interposed between the light string circuit and such ornaments so as to ensure that only a very low voltage, say 3 or 4 volts AC or DC, can be taken from the adapter for the purpose of powering the ornament.

### SUMMARY OF THE INVENTION

According to a first aspect of the invention there is provided adapter means for insertion between the socket of a light string and an electrically operable ornament, the adapter comprising or including a plug for insertion into a light socket of the light string for taking line voltage therefrom, a housing connected to the plug and including voltage and current limit means to provide a required maximum voltage and current as an output load, and safety circuit and current limiter means for the light string adapted to limit or arrest the flow of current from the light string to the adapter means in the event of overheating thermal or voltage overload.

Conveniently, the adapter means includes an output socket to which may be connected a suitably shaped plug on the end of a pigtail lead of an electrically operable ornament so that different such ornaments may be selectively connected to the adapter means as desired.

Preferably, the output socket means and attendant “pigtail” plug means are shaped to selectively allow output of AC or DC current, such as by being keyed with respect to each other, thereby providing means whereby e.g. a DC operable ornament may be provided with only DC current and an AC operable ornament may be provided with only AC current.

According to a second aspect of the invention there is provided an electrically operable ornament display device which includes a pigtail connectable to a light string, preferably via the adapter means of the first aspect of the invention, the ornament display means including a housing for an electric motor operable by a light string via the pigtail when connected thereto, the motor including means for moveably supporting an ornament, either directly or indirectly, one or more electric lamps extending from the housing and adapted to illuminate an ornament supported by the motor, and a control circuit operable to modulate the supply of electricity to the or each lamp to a selected condition, to thereby highlight the ornament.

Conveniently, the or each electric lamp comprises light emitting diodes (LED's) and the modulation provides fades, flickers, strobes or steady light output from the or each lamp in order to illuminate an ornament.

Conveniently, the motor may provide for rotating and/or up and down movement of an ornament held thereby, either directly or indirectly.

According to a third aspect of the invention there is provided an electrically operable ornament display device which includes a pigtail connectable to a light string, preferably via the adapter means of the first aspect of the invention, the display device comprising a housing containing a control circuit operable to modulate the supply of electricity to one or more lamps extending from the housing, the or each lamp being selectively movable to illuminate an ornament supported by the housing, the control circuit also being operable to modulate the supply of electricity to the or each lamp to a selected condition, such as fading, flickering, strobing or steady light output.

### BRIEF DESCRIPTION OF THE DRAWINGS

FIG. 1 is a perspective view of part of an ornamental light string, and adapter and according to the first aspect of the invention connected to part of a pigtail for powering an ornament (not shown),

FIG. 2 shows the adapter of FIG. 1 disconnected from the pigtail,

FIG. 3 is a circuit diagram for the adapter of FIGS. 1 and 2 as connected to an ornamental light string,

FIG. 4 is a perspective view of the ornament display device according to the second aspect of the invention attached to the adapter of FIG. 1,

FIG. 5 is an exposed to view of the ornament display device of FIG. 4, and

FIG. 6 is a perspective view of an ornament display device according to the third aspect of the invention connected to the adapter of FIG. 1.

### DETAILED DESCRIPTION OF THE DRAWINGS

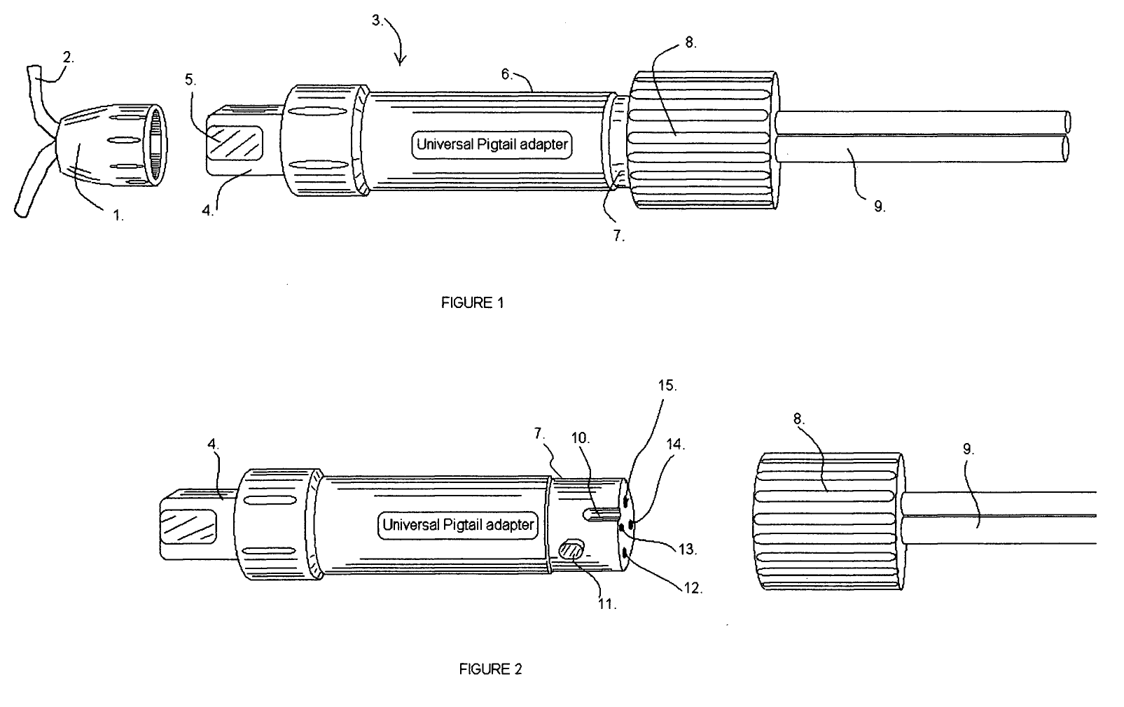

Referring firstly to FIG. 1, there is shown a conventional light socket 1 of a series wired electric light string 2. Ordinarily, an electric light bulb is inserted in the socket 1, there being, typically, 35 to 50 such light bulbs in a conventional light string circuit, all of which must be working or otherwise capable of conducting electricity across the terminals of each socket 1, such as by the use of an oxide shunt within the bulb itself which allows the bulb to conduct electricity even if the filament has burned out. Accordingly, it will be apparent that the line voltage of, say, 110 V is shared equally between the number of light sockets in the light string 2 except that where faulty bulbs are present in the string and shunts are used to close the circuit the remaining sockets with working bulbs draw increasing load from the circuit, such that care needs to be taken to ensure that the increased load on fewer bulbs does not cause them to burn out or otherwise cause overheating of the light string and hence present a fire hazard. Similarly, where a conventional pigtail connector is used in place of a bulb to provide electrical power for an ornament and it is necessary to ensure that the electrical components within the ornament do not draw too much power from the light string since, otherwise, the light bulbs will dim and a very high voltage, theoretically up to the line voltage, will be applied to the components in the ornament via the pigtail connection. For this reason, various temperature, current and voltage restrictions are imposed upon such ornaments as a means of trying to safeguard the end user against electric shock and/or fire.

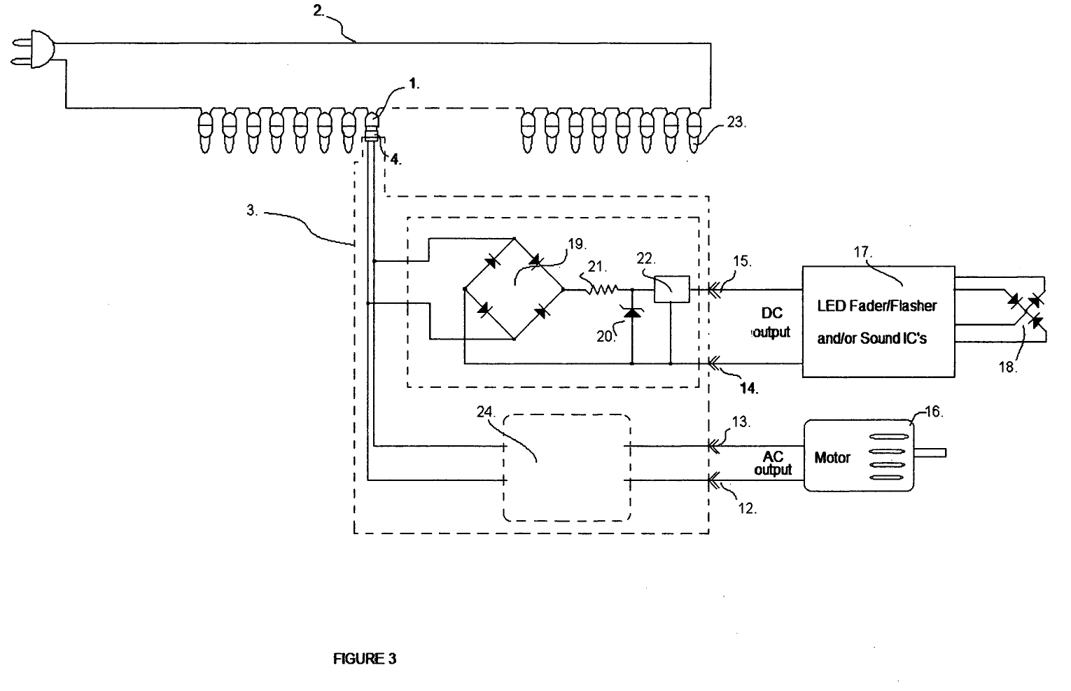

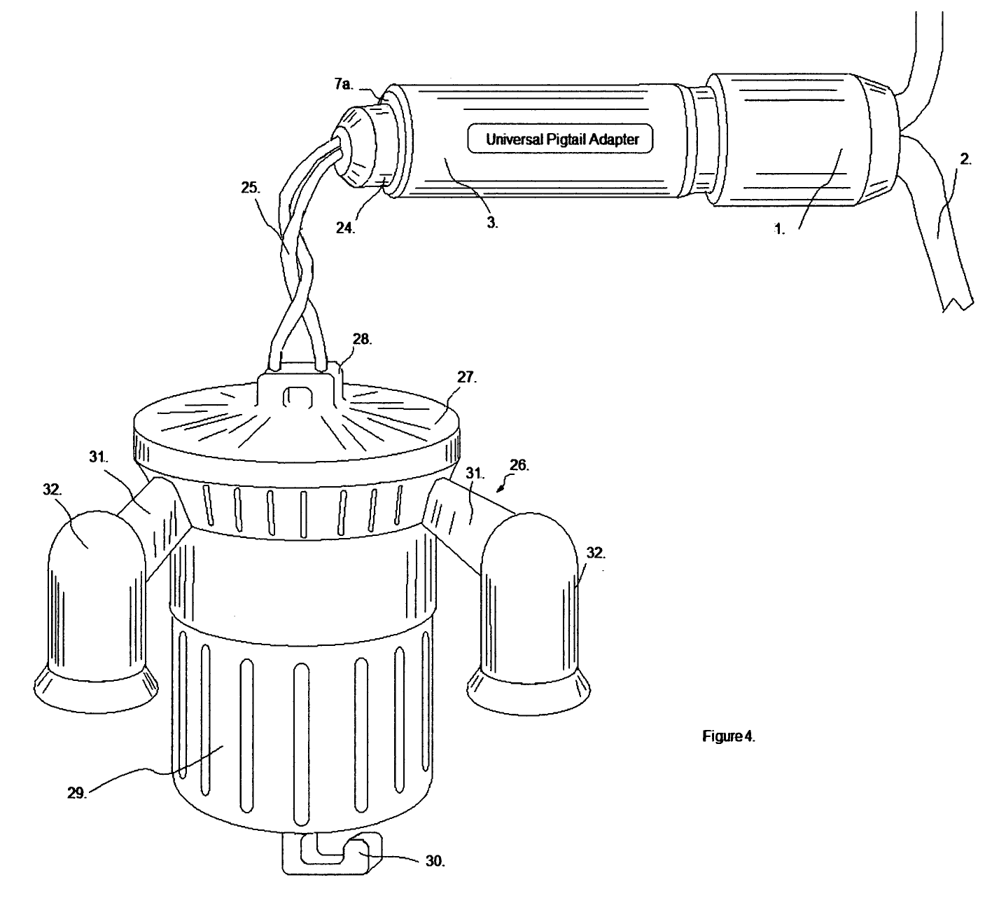

In accordance with the first aspect of the invention and as a means of obviating the foregoing problems there is provided adapter means in the form of a pigtail adapter 3 having a plug 4 for insertion into the socket 1, the plug 4 having an electric terminals 5 (only one of which is shown) corresponding to the plugged end of a conventional pigtail connector and of a conventional light bulb. The adapter 3 also includes a cylindrical housing 6 remote from the plug 4, the housing 6 including voltage and current limit means (shown in FIG. 3) as well as a safety circuit and current limit means for the light string 2 adapted to limit or arrest the flow of current from the light string to the adapter means 3 in the event of overheating or voltage overload.

Out of the other end of the housing 6 remote from the plug 4 there is an output socket 7 (shown more clearly with reference to FIG. 2) for receiving thereon a correspondingly shaped socket 8 of a pigtail connector 9 (only part of which is shown). The output socket 7 includes a grooved keyway 10 and locking pin 11 connectable with correspondingly shaped formations (not shown) in the pigtail socket 8 and by which the pigtail socket 8 can be releaseably secured to the output socket 7 of the adapter 3 by a push and twist. The output socket 7 also includes four electrical contact or output ends 12, 13, 14 and 15 which electrically connect with corresponding electrical contacts (not shown) in the pigtail socket 8 when the latter is secured thereto in the manner as shown in FIG. 1.

Turning now to FIG. 3, there is shown in broken outline a circuit diagram for the pigtail adapter 3 having an input end in the form of the plug 4 which is shown inserted within the socket 1 of the light string 2 and output ends 12, 13, 14 and 15 of which output ends 12, 13 provide low voltage AC output voltage to an electric motor 16 and outlets 14, 15 provide low voltage DC output to a modulator 17 for modulating current to a set of LEDs shown generally at 18, in this case a set of three such LEDs. Although it will be understood that any suitable electric circuit may be used, the one shown in FIG. 3 includes a simple full-wave bridge rectifier 19 with a Zener diode 20, resistor 21 and thermal protector 22. The Zener diode 20 begins to conduct when the rectified voltage from the bridge circuit 19 reaches its Zener voltage, typically about 3.9 volts and therefore provides a load to the bridge 19 which clamps the output voltage to the Zener voltage. When this happens all the current through the light string 2 is conducted through the bridge 19, Zener diode 20 and the resistor 21, allowing all the bulbs 23 in the string 2 to receive their operating current, whereupon the voltage at the terminals 14, 15 equals the bulb voltage of typically around 3 to 4 volts, dependent upon how many bulbs are in the light string 2. There are, however, other ways of controlling the load current in order to ensure the voltage at the terminals 14, 15 is never significantly greater than the voltage applied to the bulbs 23.

For AC operation a control block 24 may be used to the same effect i.e. to control the voltage delivered to the AC terminals 12, 13, although in the example given, because of the presence of the DC clamping circuit described above, no other control is needed and whatever DC voltage occurs at terminals 14 and 15 will set the level of AC voltage occurring at terminals 12 and 13. Accordingly, it will be apparent that in the invention, the pigtail adapter 3 acts as both a load for the light string 2 but also limits the maximum voltage available at the terminals 12, 13, 14 and 15, in the example shown to the voltage applied to the bulbs 23. This means that the voltage supplied to the electric motor 16 or the LEDs 18 is never line voltage, thereby obviating the need for the wiring in between to be of the same diameter as the wiring of the string 2. In turn, this means that very thin low-wattage wires may be used to power an ornament, thereby significantly improving the aesthetic appeal of the ornament, and further obviating the need for warning labels to be attached to the ornament. Furthermore, by never being exposed to the risk of line voltage but only to a modest 3 or 4 volts, the ornament portion does not require to be UL tested, along with all the expense and delay involved in such testing, as is conventionally the case.

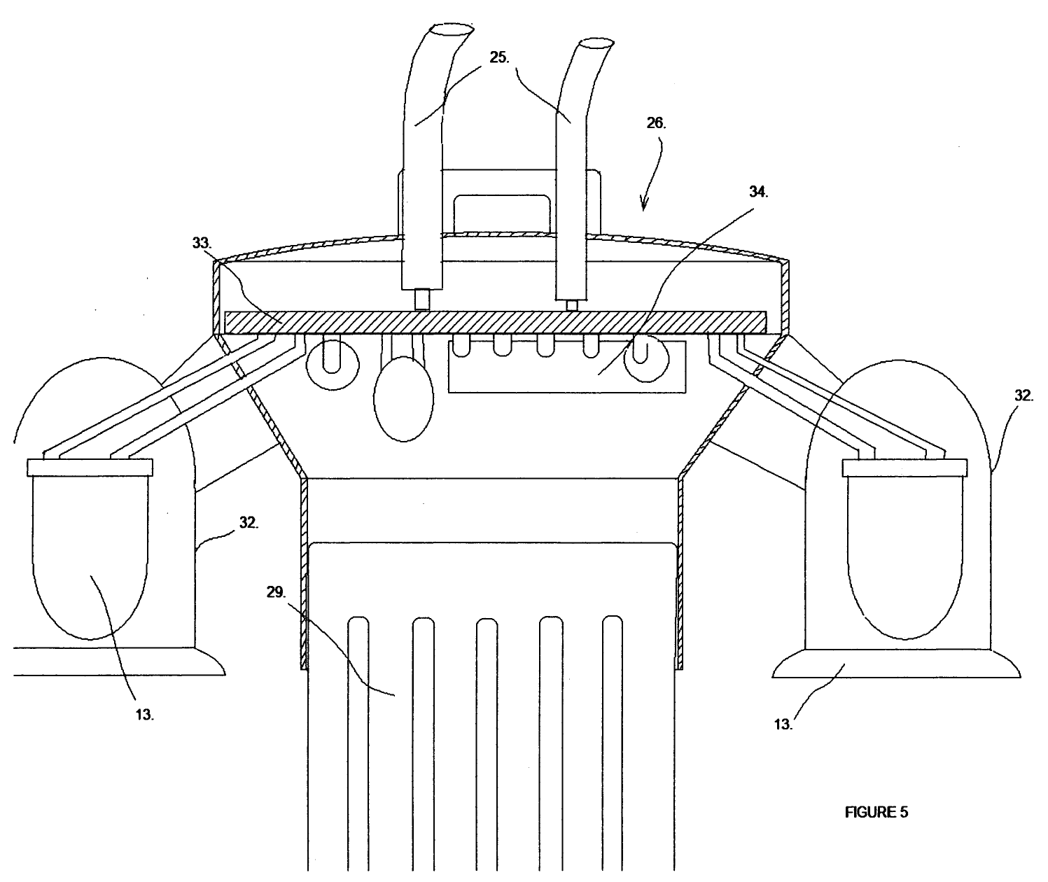

Turning now to FIG. 4 there is shown a second embodiment of the invention in which the pigtail adapter 3 is shown plugged into the socket 1 of a light string 2 and has an outlet socket end 7a adapted to receive the plug end 24 of a pigtail 25 electrically connected at its other end to a motorised ornament display device shown generally at 26. The ornament display device 26 includes a generally cylindrical housing 27 projecting upwardly from which is an eye 28 by which the ornament display device 26 may be attached to e.g. a Christmas tree, and depending from which is an electric motor 29 having a drive shaft (not shown) to which is driveably secured a hook 30 onto which ornaments may be hung and rotated. To provide illumination for the ornament when mounted on the hook, radially outwardly extending arms 31 are provided, onto the ends of which are respective lamp holders 32.

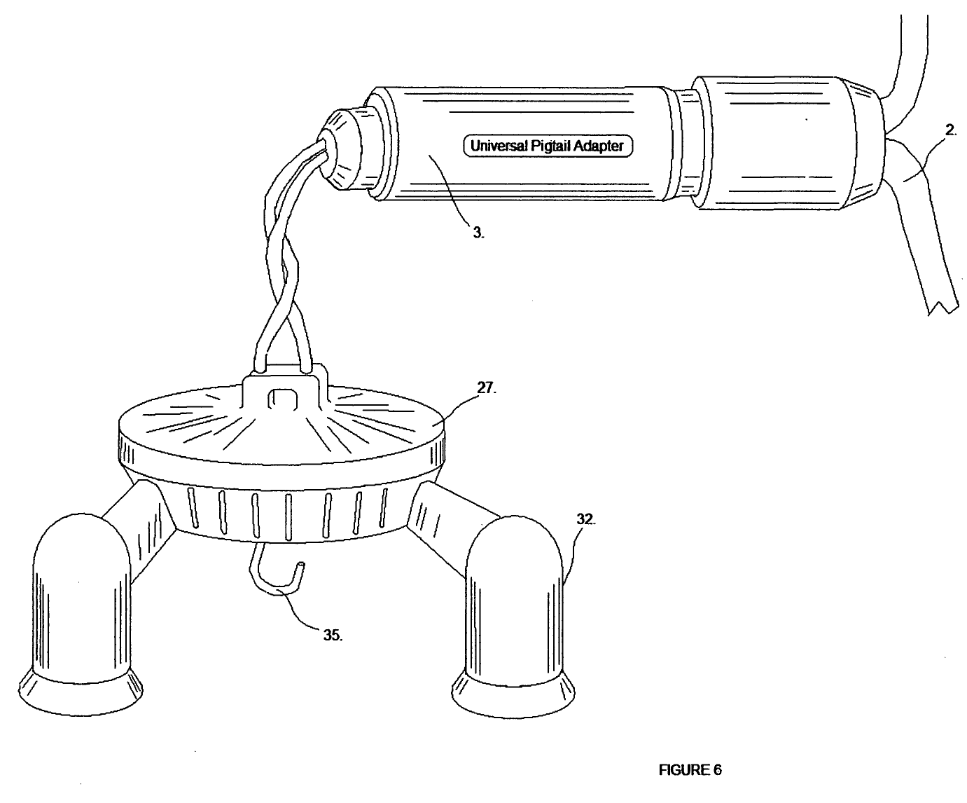

As will be seen from FIG. 5, the lamp holders 32 contain LEDs 13 which are electrically connected to a conventional pigtail 25 (which may be plugged into a pigtail adapter of the invention) via a printed circuit board (PCB) 33 which includes electronic components shown generally at 34 for controlling the motor 29 and the LEDs 13, the control circuit of which the PCB 33 and components 34 are comprised being operable to modulate the supply of electricity to the LEDs 13 to a selected condition, such as fading, flickering, strobing or steady light output. The LEDs 13 may, of course, be of different colours so that one colour only may be strobed or one colour followed by another, or different combinations as desired by the user of the ornament display device 26.

A third embodiment of the invention is shown in FIG. 6, where like parts are numbered accordingly, but in which the motor 29 of FIGS. 4 and 5 has been dispensed with, to be replaced by a hook 35 which is fixed to and depends from the lower part of the housing 27, with all other parts being identical. This simplified embodiment of the invention can therefore nevertheless still provide an interesting enhanced effect for an ornament hanging from the hook 35, particularly for an ornament which is not suitable for rotation or movement up and down or where movement of the ornament is not required. With effectively no or very few moving parts this embodiment of the invention nevertheless still provides a useful means of enhancing the aesthetic qualities of the ornament and its immediate surroundings.

It will be understood to those persons skilled in the art that the invention in its several aspects is illustrative of the simplicity and adaptability of the method by which it may be performed and is not intended to be limited thereby.

What I claim is:

1. Adapter means for insertion between the socket of a light string and an electrically operable ornament, the adapter comprising or including a plug for insertion into a light socket of light string for taking line voltage therefrom, a housing connected to the plug and including voltage and current limit means to provide a required maximum voltage and current as an output load, and safety circuit and current limiter means for the light string adapted to limit or arrest the flow of current from the light string to the adapter means in the event of overheating or voltage overload.

2. Adapter means according to claim 1 wherein the adapter means includes an output socket to which may be connected a suitably shaped plug on the end of a pigtail lead of an electrically operable ornament so that different such ornaments may be selectively connected to the adapter means as desired.

3. Adapter means according to claim 1 or claim 2 wherein the output socket means are shaped to fit an attendant pigtail plug to selectively allow output of AC or DC current.

4. Adapter means according to claim 3 wherein the output socket means is then keyed with respect to an attendant pigtail plug.

5. An electrically operable ornament display device which includes a pigtail connectable to a light string, preferably via the adapter means of the first aspect of the invention, the ornament display means including a housing for an electric motor operable by a light string via the pigtail when connected thereto, the motor including means for moveably supporting an ornament, either directly or indirectly, one or more electric lamps extending from the housing and adapted to illuminate an ornament supported by the motor, and a control circuit operable to modulate the supply of electricity to the or each lamp to a selected condition, to thereby highlight the ornament.

6. An ornament display device according to claim 5 wherein the or each electric lamp comprises light emitting diodes (LED's) and the modulation provides fades, flickers, strobes or steady light output from the or each lamp in order to illuminate an ornament.

7. An ornament display device according to claim 5 or claim 6 wherein the motor provides for rotating and/or up and down movement of an ornament held thereby, either directly or indirectly.

8. An electrically operable ornament display device which includes a pigtail connectable to a light string, preferably via the adapter means of the first aspect of the invention, the display device comprising a housing containing a control circuit operable to modulate the supply of electricity to one or more lamps extending from the housing, the or each lamp being selectively movable to illuminate an ornament supported by the housing, the control circuit also being operable to modulate the supply of electricity to the or each lamp to a selected condition, such as fading, flickering, strobing or steady light output.
